(19) United States
(12) Patent Application Publication
(10) Pub. No.: US 2011/0192873 A1
(43) Pub. Date: Aug. 11, 2011

(54) Storage and carrying racks

(76) Inventor: Stephen Pavlik, Sterling, MI (US)

(21) Appl. No.: 13/066,185

(22) Filed: Apr. 8, 2011

Related U.S. Application Data
(63) Continuation-in-part of application No. 12/387,855, filed on May 8, 2009.

(51) Int. Cl. B60R 9/00

(52) U.S. Cl. 224/488

(57) ABSTRACT

Storage and carrying racks for a military hitching apparatus. The carrying racks allow for the quick hitching and unhitching of various trailers, cannon, and other military equipment that are towed on wheels.

This application is a utility application claiming priority from U.S. Utility application having Ser. No. 12/387,855, filed on May 8, 2009 and U.S. provisional patent application having Ser. No. 61/127,121, filed May 9, 2008.

### BACKGROUND OF THE INVENTION

This invention deals with storage and carrying racks for a military hitching apparatus. Military vehicles are equipped with a universal hitching system that is called a pintle mount. This system allows for the quick hitching and unhitching of various trailers, cannon, and other military equipment that are towed on wheels. This arrangement is opposed to the conventional ball hitch that is common on civilian vehicles. The pintle mount consists of a hitch on the towing vehicle that is essentially a clamp apparatus wherein the lower portion is stabilized and the upper portion moves in an up and down motion to open and close the clamp. The other part of the pintle mount is the tow bar.

In today's modern army, it is a requirement that such a hitching mechanism must be carried with each vehicle. Typically, this hitching means is stored in the rear of the vehicle and it takes on the order of 10 to 15 minutes to drop the tailgate of the vehicle, open the storage bin, release the hitching mechanism, lay the hitching mechanism on the ground, then pick it up again, and attach it to the vehicle and the towed vehicle, and that is because the hitching mechanism is stored inside of the carrying vehicle and can only be reached when the tailgate of the carrying vehicle is dropped downwardly. The hitching mechanism has then to be laid aside until the storage cabinet is closed and the tailgate moved upwardly to its closed position. Usually, this means placing the hitching mechanism on the ground and then picking it up again when the storage bin and the tailgate have been closed.

The storage and carrying racks of this invention overcome all of the problems associated with the current means of carrying and installing the hitching means.

The inventor herein is not aware of any prior art storage and carrying racks that will accomplish the same objectives and provide the benefits of the device of the instant invention.

### THE INVENTION

What is therefore disclosed and claimed herein are storage and carrying racks wherein one embodiment comprises a mounting plate having a near end, a distal end, a bottom edge, a front surface, a back surface and a top edge.

There is a hook mounted near the distal end and on the front surface of the mounting plate and at least one set of openings through the front surface and through the back surface of the mounting plate.

There is at least one upper bracket mounted perpendicularly to the front surface and near the top edge of the mounting plate, near the near end and at least two spaced-apart lower brackets mounted perpendicularly to the front surface and near the bottom edge of the mounting plate, at least one lower bracket is mounted near the near end of the mounting plate.

The second embodiment comprises a storage and carrying rack comprising a mounting bar having a near end and a distal end, a top surface and a front. There is a vertical post mounted on the top surface at the near end.

There is a first U-shaped bracket fixedly mounted on the top surface and near the distal end and a second U-shaped bracket mounted on the top surface and near the near end, wherein each U-shaped bracket has a bottom bar, a top bar and a back bar, wherein the top bar has a distal end. There is a first opening in each top bar at the distal end.

Each U-shaped bracket has a strap fixedly attached to the back bar, wherein the end of the strap not attached to the back bar has a fastener attached to it.

Each back bar has a second opening and a slot therethrough for attaching the storage and carrying rack to a bumper of a vehicle.

### BRIEF DESCRIPTION OF THE DRAWINGS

FIG. 1 is a full front view of a Humvee vehicle with the first embodiment inventive device mounted on the front of the vehicle and a tow eye mounted on the device.

FIG. 2 is a full front view of a first embodiment of the device of this invention.

FIG. 3 is an end view of a first embodiment of the device of this invention.

FIG. 4 is a full top view of a tow eye that is mounted on the first embodiment of the inventive device of this invention.

FIG. 5 is a view in perspective of a second embodiment device of this invention.

FIG. 6 is a full side view of a bracket of this invention showing one possible arrangement of the openings for fastening a strap to the bracket.

FIG. 7 is a front end view of the bracket showing the mounting opening and slot for mounting the storage and carrying rack of this invention.

FIG. 8 is a full front view of the post showing an opening for a tether to help hold the component of FIG. 4 in place.

FIG. 9 is a full front view of a Humvee vehicle with the second embodiment inventive device mounted on the front of the vehicle and a tow eye mounted on the device.

### DETAILED DESCRIPTION OF THE DRAWINGS

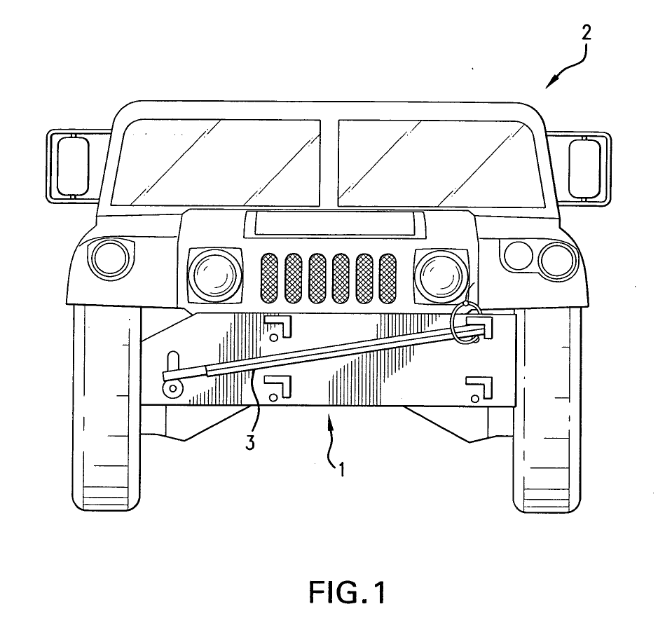

FIG. 1 is a full front view of a depiction of a Humvee vehicle 2 with the first embodiment inventive device 1 mounted on the front of the vehicle 2 and a pintle tow bar 3 mounted on the device 1.

The hitching device shown in FIG. 4 is called a pintle tow bar 3 and is comprised of an eye 4 that drops down over a hitch mounted on the towing vehicle (not shown). The pintle tow bar 3 has two long tow bars attached to it, one is static 5 and the other is movable 6 around the perimeter of the eye 4 to enable the hitch to fit various sized vehicles. The ends 7 of the long tow bars distal to the eye 4 are fitted with a means 8 to attach to a towed trailer or the like.

In use, the pintle tow bar 3 eye 4 drops over the lower part of the clamp hitch and the top part of the hitch drops down to hold the pintle tow bar 3 on the hitch. The means 8 on the distal ends 7 are essentially yolks, with aligned holes through the yolks, in which is fitted a pin. The pin is then fitted with a cotter pin to hold the pin in place.

The clamp mechanism and the eye 4 of the pintle tow bar are designed such that when coupled together, they form a FIG. 8. This configuration allows for the maximum flexibility for the pintle tow bar 3 in rough terrain.

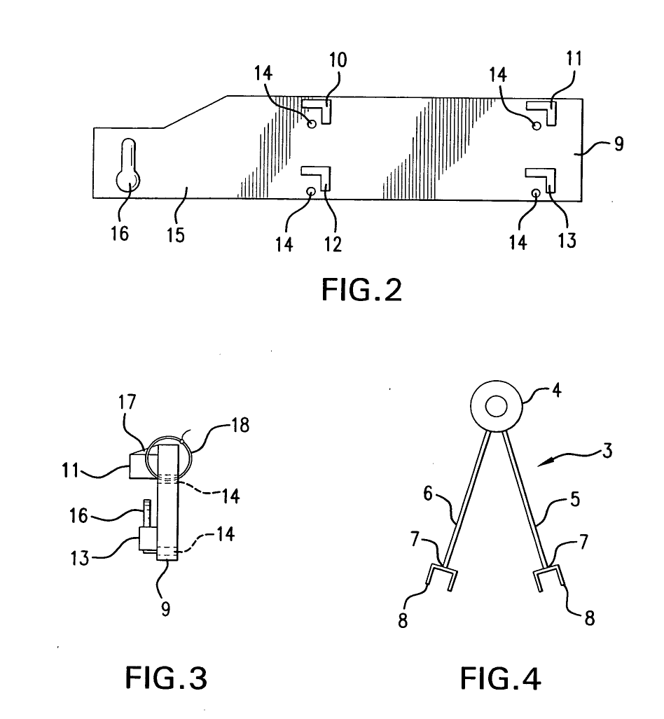

Turning now to the invention, the device 1 of this invention is comprised of a flat metal panel 9 (FIG. 2) that has spaced top bars 10 and 11, and spaced bottom bars 12 and 13 that are permanently attached vertically to the flat plane of the panel 9. Bottom bars 12 and 13 act as a shelf onto which the long tow bars 5 and 6 can rest until put into use or stored up against the top bar 11. As illustrated herein, the bars 10, 11, 12, and 13 are manufactured from angle iron, but this is not critical to the invention. What is needed is bar material that will endure the rigors of the use of the device.

The flat panel 9 has at least four openings 14 through it to allow the attachment of the flat panel to the front of the Humvee as shown in FIG. 1.

On the front surface 15, essentially on the end opposite of the spaced top and bottom bars is a hook 16 on which the eye 4 of the pintle tow bar 3 rests during storage. Optionally, there can be provided a support brace 17 as shown in FIG. 3. In addition, the device of this invention provides for a securing strap 18, also shown in FIG. 3.

The combination of the eye 4, the arms 5 and 6, and the attachment means 8 distal ends 7 weigh about two hundred pounds and thus traditionally has to be carried by the vehicle to which the towed vehicles have to be attached. The device of this invention provides a means of storing that is convenient and a means of holding the pintle tow bar for eventual use without having to place it on the ground to be lifted again.

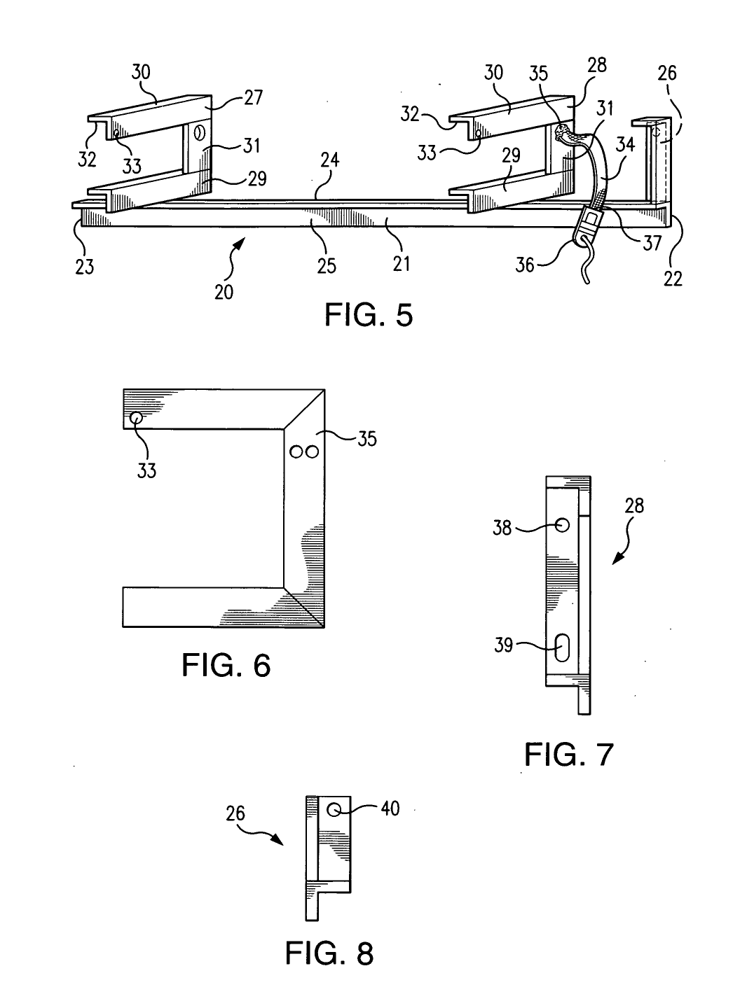

Turning now to the second embodiment of this invention and with reference to FIG. 5 wherein there is shown the device 20 comprised of a mounting bar 21 having a near end 22 and a distal end 23, a top surface 24 and a front 25.

There is a vertical post 26 mounted on the top surface 24 at the near end 22 of the mounting bar 21. The vertical post 26 is the place where the eye 4 of the pintle tow bar 3 is placed to stabilize the tow bar. The vertical post is also shown in FIG. 8 as full front view showing the opening 40 that can be used for a tether for holding the pintle eye down.

There is a first U-shaped bracket 27 fixedly mounted, for example, by welding, or bolting, to the top surface 24 and near the distal end 23. There is a second U-shaped bracket 28 mounted on the top surface 24 and near the near end 22. Each U-shaped bracket 27 and 28 has a bottom bar 29, a top bar 30, and a back bar 31, wherein the top bar 30 has a distal end 32. There is a first opening 33 in each top bar 30 at the distal end 23 to accommodate a fastener for a strap described infra. The FIG. 7 shows a full front end view of the bracket showing the mounting opening 38 and the slot 39.

Each U-shaped bracket 27 and 28 has a strap 34 fixedly attached at point 35 to the back bar 31 (strap not shown on 27 for clarity's sake). The end 36 of the strap 34 not attached to the back bar 31 has a fastener 36 attached to it at point 37. Each back bar 31 has a second opening 38 and a slot 39 for attaching the storage and carrying rack 20 to the front of a vehicle 2 (FIG. 1). The straps can be manufactured from webbing, rope, chain, steel band, or something similar as this is not critical to the invention as long as the strap has sufficient strength to maintain the pintle bar in place.

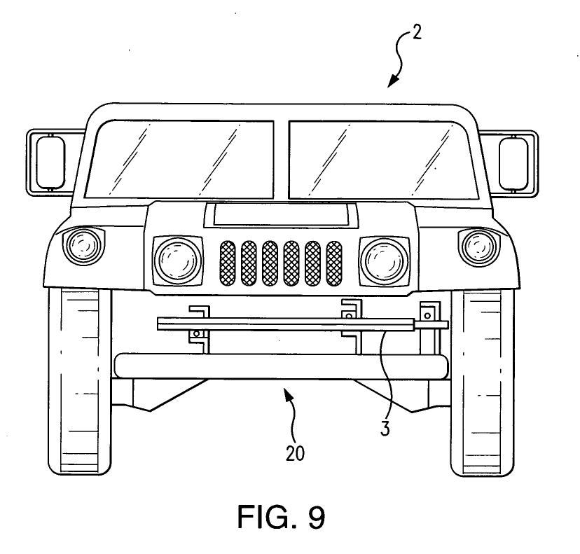

FIG. 9 is a full front view of a Humvee vehicle 2 with the second embodiment inventive device 20 mounted on the front of the vehicle 2, and a tow eye 3 mounted on the device 20.

The devices of this invention are preferably manufactured out of metal, most preferably steel or cast iron.

What is claimed is:

1. A storage and carrying rack comprising:
a. a mounting plate having a near end, a distal end, a bottom edge, a front surface, a back surface and a top edge;
b. a hook mounted near the distal end and on the front surface of the mounting plate;
c. at least one set of openings through the front surface and through the back surface of the mounting plate;
d. at least one upper bracket mounted perpendicularly to the front surface and near the top edge of the mounting plate, near the near end;
e. at least two spaced-apart lower brackets mounted perpendicularly to the front surface and near the bottom edge of the mounting plate, at least one lower bracket mounted near the near end of the mounting plate.

2. A storage and carrying rack comprising:
a mounting bar having a near end and a distal end, a top surface and a front;
a vertical post mounted on the top surface at the near end;
a first U-shaped bracket fixedly mounted on the top surface and near the distal end and a second U-shaped bracket mounted on the top surface and near the near end;
each U-shaped bracket having a bottom bar, a top bar and a back bar, wherein the top bar has a distal end, there being a first opening in each top bar at the distal end;
each U-shaped bracket having a strap fixedly attached to the back bar, wherein the end of the strap not attached to the back bar has a fastener attached thereto;
each back bar having a second opening and a slot therethrough for attaching the storage and carrying rack to a bumper of a vehicle.
